(19) United States
(12) Patent Application Publication
(10) Pub. No.: US 2006/0177767 A1
(43) Pub. Date: Aug. 10, 2006

(54) Photosensitive resin composition, thin film panel including a layer made from photosensitive resin composition, and method for manufacturing thin film panel

(75) Inventor: Dong-Ki Lee, Seoul (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/348,924

(22) Filed: Feb. 6, 2006

(30) Foreign Application Priority Data
Feb. 7, 2005 (KR) 10-2005-0011464

(51) Int. Cl. G03C 1/76

(52) U.S. Cl. 430/270.1

(57) ABSTRACT

A photosensitive resin composition includes an acrylic resin, a quinone diazide, and a solvent. The solvent includes a propylene glycol alkyl ether acetate and a trimethyl pentanediol monoisobutyrate (2,2,4-trimethyl-1,3-pentanediol monoisobutyrate). The propylene glycol alkyl ether acetate includes an alkyl group preferably containing about 1-5 carbon atoms. The resin composition may be used for making thin film panels for display devices.

### CROSS-REFERENCE TO RELATED APPLICATION(S)

This patent application claims priority from Korean Patent Application No. 10-2005-0011464 filed on Feb. 7, 2005, the content of which is incorporated by reference herein in its entirety.

### BACKGROUND OF THE INVENTION

(a) Field of the Invention

The present invention relates generally to a photosensitive resin composition, and in particular, to a photosensitive resin composition for insulation of a display panel.

(b) Description of Related Art

An active type display device such as an active matrix (AM) liquid crystal display (LCD) and an active matrix organic light emitting diode (OLED) display includes a plurality of pixels arranged in a matrix. Each matrix includes switching elements and a plurality of signal lines such as gate lines and data lines for transmitting signals to the switching elements. The switching elements of the pixels selectively transmit data signals from the data lines to the pixels in response to gate signals from the gate lines for displaying images. The pixels of an LCD adjust the transmittance of incident light depending on the data signals, while those of the OLED display adjust the luminance of emitted light according to the data signals.

The LCD and the OLED displays include a panel provided with the TFTs, the field-generating electrodes, the signal lines, etc. The panel has a layered structure that includes several conductive layers and insulating layers. The gate lines, the data lines, and the field-generating electrodes are formed of different conductive layers and separated by insulating layers.

The insulating layers are made of inorganic or organic insulators. Organic insulators have a transmittance higher than the inorganic insulators to increase the luminance and the aperture ratio. The several organic insulators have photosensitivity that allows them to be patterned by lithography without etching, thereby simplifying the formation of the desired insulating layer.

Conventional photosensitive organic insulating layers often have spots or stains. The undesirable formation of these spots or stains becomes more frequent as the display devices increase in size. Examples of the stains include horizontal stains along the direction in which the nozzle moves where the nozzle is a slit-type nozzle of a coating device, vertical stains along the lengthwise direction of the slit type nozzle, and irregular spots generating an entire surface of a substrate. In addition, portions of the organic layer near the edges of a substrate are thicker than other portions, and the thicker portions may not completely dissolve during development. The undissolved portions may result in stains. Of the various coating methods that may be used to deposit the organic layer, slit coating may result in a particularly great variance of the thickness as compared with spin coating since the centrifugal force in the spin coating may reduce the variance of the thickness. Such a variance of the thickness may degrade the image quality of the display device. A method of depositing the insulating layer without forming as many spots or stains as with the current method is desired.

### SUMMARY OF THE INVENTION

In one aspect, the invention is a photosensitive resin composition that includes an acrylic resin, a quinone diazide, and a solvent. The solvent includes a propylene glycol alkyl ether acetate and a trimethyl pentanediol monoisobutyrate (2,2,4-trimethyl-1,3-pentanediol monoisobutyrate).

The solvent may include about 60 to about 95 wt. % propylene glycol alkyl ether acetate and about 5 to about 40 wt. % trimethyl pentanediol monoisobutyrate.

In another aspect, the invention is a thin film panel that includes: a substrate; a thin film pattern formed on the substrate; and an insulating layer formed on the thin film pattern. Thah insulating layer is made from a photosensitive resin composition including an acrylic resin, a quinone diazide, and a solvent. The solvent includes a propylene glycol alkyl ether acetate and a trimethyl pentanediol monoisobutyrate.

A method of manufacturing a thin film panel is also provided. The method includes: forming a thin film pattern on a substrate; coating a photosensitive resin composition including an acrylic resin, a quinone diazide, and a solvent; performing a light exposure on the photosensitive resin composition; and developing the photosensitive resin composition. The solvent includes a propylene glycol alkyl ether acetate and a trimethyl pentanediol monoisobutyrate.

### BRIEF DESCRIPTION OF THE DRAWINGS

The present invention will become more apparent by describing embodiments thereof in detail with reference to the accompanying drawing in which:

FIG. 1 is a layout view of a TFT array panel according to an embodiment of the present invention;

FIG. 2 is a sectional view of the TFT array panel shown in FIG. 1 taken along line II-II′;

FIGS. 3A, 4A, 5A and 6A are layout views of the TFT array panel shown FIGS. 1 and 2 in intermediate steps of a manufacturing method thereof according to an embodiment of the present invention;

FIG. 3B is a sectional view of the TFT array panel shown in FIG. 3A taken along line IIIB-IIIB′;

FIG. 4B is a sectional view of the TFT array panel shown in FIG. 4A taken along line IVB-IVB′;

FIG. 5B is a sectional view of the TFT array panel shown in FIG. 5A taken along line VB-VB′;

FIG. 6B is a sectional view of the TFT array panel shown in FIG. 6A taken along line VIB-VIB′; and

FIG. 7 illustrates a standard estimation of the stains of a photosensitive resin film.

### DETAILED DESCRIPTION OF EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

A photosensitive resin composition according to the present invention includes an acrylic resin, a quinone diazide, and a solvent. The solvent includes a propylene glycol alkyl ether acetate including an alkyl group preferably containing about 1-5 carbon atoms and a trimethyl pentanediol monoisobutyrate.

The acrylic resin may include an acrylic copolymer. The acrylic copolymer may be obtained by a radical reaction of a monomer derived from a norbornene carboxylate having Chemical Formula 1 under a solvent and a polymerization initiator. 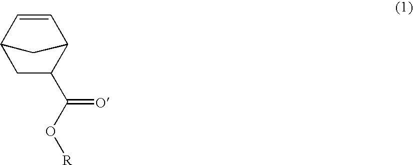
where R is —OH or —CH₃.

The monomer derived from the norbornene carboxylate having Chemical Formula 1 may be one or more of methyl norbornene carboxylate, ethyl norbornene carboxylate, n-butyl norbornene carboxylate, sec-butyl norbornene carboxylate, t-butyl norbornene carboxylate, isopropyl norbornene carboxylate, cyclohexyl norbornene carboxylate, 2-methyl cyclohexyl norbornene carboxylate, dicyclopentanyloxy norbornene carboxylate, dicyclopentanyloxy ethyl norbornene carboxylate, isobornyl norbornene carboxylate, dicyclopentenyl norbornene carboxylate, dicyclopentanyl norbornene carboxylate, phenyl norbornene carboxylate, benzyl norbornene carboxylate, and 2-hydroxyethyl norbornene carboxylate. Preferred are t-butyl norbornene carboxylate and isobornyl norbornene carboxylate, which give good reactivity for copolymerization and good solubility in an alkaline aqueous solution.

The weight percentage of the monomer derived from the norbornene carboxylate in the total monomer content of the copolymer is preferably from about 20 to about 40 wt. %, and more preferably, from about 20 to about 30 wt. %. When the amount of the monomer is less than about 20 wt. %, the heat resistance becomes lower. When the amount of the monomer is greater than about 40 wt. %, the solubility in the alkaline aqueous solution used as a developer is reduced.

The weight average molecular weight of the acrylic copolymer determined by gel permeation chromatography (GPC) using a polystyrene standard is preferably from about 5,000 to about 30,000 and more preferably from about 5,000 to about 20,000. The average molecular weight less than about 5,000 may deteriorate development, insoluble fraction, pattern shaping, heat resistance, etc. When the average molecular weight is greater than about 30,000, the sensitivity is reduced or pattern shaping is degraded. The above-described range of the average molecular weight of the acrylic copolymer keeps an appropriate insoluble fraction (i.e., the ratio of remnant after development) and provides high development speed.

The weight percentage of the copolymer including the monomer derived from the norbornene carboxylate in the photosensitive resin is preferably from about 5 to about 40 wt. %.

The quinone diazide in the photosensitive resin composition may be one of 1,2-quinone diazides, examples of which include 1,2-benzoquinone diazide sulfonate esters, 1,2-benzoquinone diazide sulfonate esters, 1,2-naphotoquinone diazide sulfonate esters, 1,2-benzoquinone diazide sulfonate amides, and 1,2-naphotoquinone diazide sulfonate amides.

Examples of quinone diazides include:

1,2-naphthoquinone diazide sulfonate esters of trihydroxybenzophenone such as 2,3,4-trihydroxybenzophenone-1,2-naphthoquinonediazide-sulfonate ester, 2,3,4-trihydroxybenzophenone-1,2-naphthoquinonediazide-5-sulfonate ester, 2,4,6-trihydroxybenzophenone-1,2-naphthoquinonediazide-4-sulfonate ester, and 2,4,6-trihydroxybenzophenone-1,2-naphthoquinonediazide-5-sulfonate ester;

1,2-naphthoquinone diazide sulfonate esters of tetrahydroxybenzophenone such as 2,2′,4,4′-tetrahydroxybenzophenone-1,2-naphthoquinonediazide-4-sulfonate ester, 2,2′,4,4′-tetrahydroxybenzophenone-1,2-naphthoquinonediazide-5-sulfonate ester, 2,2′,4,3′-tetrahydroxybenzophenone-1,2-naphthoquinonediazide-4-sulfonate ester, 2,2′,4,3′-tetrahydroxybenzophenone-1,2-naphthoquinonediazide-5-sulfonate ester, 2,3,4,4′-tetrahydroxybenzophenone-1,2-naphthoquinonediazide-4-sulfonate ester, 2,3,4,4′-tetrahydroxybenzophenone-1,2-naphthoquinonediazide-5-sulfonate ester, 2,3,4,2′-tetrahydroxybenzophenone-1,2-naphthoquinonediazide-4-sulfonate ester, 2,3,4,2′-tetrahydroxybenzophenone-1,2-naphthoquinonediazide-5-sulfonate ester, 2,3,4,4′-tetrahydroxy-3′-methoxybenzophenone-1,2-naphthoquinonediazide-4-sulfonate ester, and 2,3,4,4′-tetrahydroxy-3′-methoxybenzophenone-1,2-naphthoquinonediazide-5-sulfonate ester;

1,2-naphthoquinone diazide sulfonate esters of pentahydroxybenzophenone such as 2,3,4,2′,6′-pentahydroxybenzophenone-1,2-naphthoquinonediazide-4-sulfonate ester and 2,3,4,2′,6′-pentahydroxybenzophenone-1,2-naphthoquinonediazide-5-sulfonate ester;

1,2-naphthoquinone diazide sulfonate esters of hexahydroxybenzophenone such as 2,4,6,3′,4′,5′-hexahydroxybenzophenone-1,2-naphthoquinonediazide-4-sulfonate ester, 2,4,6,3′,4′,5′-hexahydroxybenzophenone-1,2-naphthoquinonediazide-5-sulfonate ester, 3,4,5,3′,4′,5′-hexahydroxybenzophenone-1,2-naphthoquinonediazide-4-sulfonate ester, and 3,4,5,3′,4′,5′-hexahydroxybenzophenone-1,2-naphthoquinonediazide-5-sulfonate ester;

1,2-naphthoquinone diazide sulfonate esters of (polyhydroxyphenyl)alkane such as bis(2,4-dihydroxyphenyl)methane-1,2-naphthoquinonediazide-4-sulfonate ester, bis(2,4-dihydroxyphenyl)methane-1,2-naphthoquinonediazide-5-sulfonate ester, bis(p-hydroxyphenyl)methane-1,2-naphthoquinonediazide-4-sulfonate ester, bis(p-hydroxyphenyl)methane-1,2-naphthoquinonediazide-5-sulfonate ester, 1,1,1-tri(p-hydroxyphenyl)ethane-1,2-naphthoquinonediazide-4-sulfonate ester, 1,1,1-tri(p-hydroxyphenyl)ethane-1,2-naphthoquinonediazide-5-sulfonate ester, bis(2,3,4-trihydroxyphenyl)methane-1,2-naphthoquinonediazide-4-sulfonate ester, bis(2,3,4-trihydroxyphenyl)methane-1,2-naphthoquinonediazide-5-sulfonate ester, 2,2′-bis(2,3,4-trihydroxyphenyl)propane-1,2-naphthoquinonediazide-4sulfonate ester, 2,2′-bis(2,3,4-trihydroxyphenyl)propane-1,2-naphthoquinonediazide-5-sulfonate ester, 1,1,3-tris(2,5-dimethyl-4-hydroxyphenyl)-3-phenylpropane-1,2-naphthoquinonediazide-4-sulfonate ester, 1,1,3-tris(2,5-dimethyl-4-hydroxyphenyl)-3-phenylpropane-1,2-naphthoquinonediazide-5-sulfonate ester, 4,4′-[1-[4-[1-[4-hydroxyphenyl]-1-methylethyl]phenyl]ethylidene])bisphenol-1,2-naphthoquinonediazide-5-sulfonate ester, bis(2,5-dimethyl-4-hydroxyphenyl)-2-hydroxyphenylmethane-1,2-naphthoquinonediazide-4-sulfonate ester, bis(2,5-dimethyl-4-hydroxyphenyl)-2-hydroxyphenylmethane-1,2-naphthoquinonediazide-5-sulfonate ester, 3,3,3′,3′-tetramethyl-1,1′-spirobiindene-5,6,7,5′,6′,7′-hexanol-1,2-naphthoquinonediazide-4-sulfonate ester, 3,3,3′,3′-tetramethyl-1,1′-spirobiindene-5,6,7,5′,6′,7′-hexanol-1,2-naphthoquinonediazide-5-sulfonate ester, 2,2,4-trimethyl-7,2′,4′-trihydroxyflavan-1,2-naphthoquinonediazide-4-sulfonate ester, and 2,2,4-trimethyl-7,2′,4′-trihydroxyflavan-1,2-naphthoquinonediazide-5-sulfonate ester.

The photosensitive resin composition may include two or more of the above-described quinone diazides.

The quinone diazides may be obtained by an esterification of a naphthoquinonediazide sulfonic halide and a phenolic compound under weak bases. Examples of the phenolic compound include 2,3,4-trihydroxybenzophenones, 2,4,6-trihydroxybenzophenones, 2,2′ or 4,4′-tetrahydroxybenzophenones, 2,3,4,3′-tetrahydroxybenzophenones, 2,3,4,4′-tetrahydroxybenzophenones, 2,3,4,2′-tetrahydroxy-4′-methylbenzophenones, 2,3,4,4-tetrahydroxy-3′-methoxybenzophenones, 2,3,4,2′ or 2,3,4,6′-pentahydroxybenzophenones, 2,4,6,3′,2,4,6,4′ or 2,4,6,5′-hexahydroxybenzophenones, 3,4,5,3′,3,4,5,4′ or 3,4,5,5′-hexahydroxybenzophenones, bis(2,4-dihydroxyphenyl) methane, bis(p-hydroxyphenyl) methane, tri(p-hydroxyphenyl) methane, 1,1,1-tri(p-hydroxyphenyl) ethane, bis(2,3,4-trihydroxyphenyl) methane, 2,2-bis(2,3,4-trihydroxyphenyl) propane, 1,1,3-tris (2,5-dimethyl 4-hydroxyphenyl)-3-phenyl propane, 4,4′-[1-[4-[1-[4-hydroxyphenyl]-1-methylethyl]phenyl]ethylidene]bisphenol, and bis(2,5-dimethyl 4-hydroxyphenyl)-2-hydroxyphenylmethane. Two or more of the above-listed compound may also be used.

The degree of esterification is preferably from about 50 to about 85%. When the degree of esterification is less than about 50%, the insoluble fraction may be degraded. When the degree of esterification is greater than about 85%, the storage stability may be reduced.

The content of the quinone diazide is preferably from about 2 to about 15 wt. %. When the amount of the quinone diazide is less than about 2 wt. %, the difference in the resolution speed between exposed portions and unexposed portions of the photosensitive resin composition may become too small to form a pattern. Where the amount of the quinone diazide is greater than about 15 wt. %, a large amount of unreacted quinone diazide may remain when only a short illumination period is applied. In this case, the solubility of an alkaline solution used as a developer is reduced and the quality of the development is degraded.

The solvent for dissolving the acrylic resin and the quinone diazide, and the surfactants includes a propylene glycol alkyl ether acetate having an alkyl group containing about 1-5 carbon atoms and a trimethyl pentanediol monoisobutyrate.

The mixture of the acrylic resin and the quinone diazide with the solvent spreads well when being coated and demonstrates appropriate evaporation speed.

Examples of the propylene glycol alkyl ether acetate in the solvent include propylene glycol methyl ether acetate, propylene glycol ethyl ether acetate, propylene glycol propyl ether acetate, propylene glycol butyl ether acetate, and propylene glycol pentyl ether acetate.

The contents of the propylene glycol alkyl ether acetate and the trimethyl pentanediol monoisobutyrate in the solvent are from about 60 to about 95 wt. % and from about 5 to about 40 wt. %, respectively, and more preferably from about 75 to about 85 wt. % and from about 15 to about 25 wt. %, respectively. In this case, the photosensitive resin composition can form a film of a uniform thickness with reduced stains.

The solvent may be used along with an organic solvent and examples of the organic solvent include:

alcohols such as methanol, ethanol, propanol, butanol, hexanol, cyclohexanol, ethylene glycol, and glycerin;

ethers such as tetrahydrofuran;

ethylene glycol ethers such as ethylene glycol monomethyl ether and ethylene glycol monoethyl ether;

ethylene glycol alkyl ether esters such as methyl cellosolve acetate and ethyl cellosolve acetate;

diethylene glycols such as diethylene glycol monomethyl ether, diethylene glycol monoethyl ether, and diethylene glycol dimethyl ether;

propylene glycol monoalkyl ethers such as propylene glycol methyl ether, propylene glycol ethyl ether, propylene glycol propyl ether, and propylene glycol butyl ether;

propylene glycol alkyl ether propionates such as propylene glycol methyl ether propionate, propylene glycol ethyl ether propionate, propylene glycol propyl ether propionate, and propylene glycol butyl ether propionate;

aromatic hydrocarbons such as benzene, toluene, xylene, and mesitylene;

ketones such as methyl ethyl ketone, cyclohexanone, and hydroxy-4-methyl-2-pentanone;

esters such as methyl acetate, ethyl acetate, propyl acetate, butyl acetate, 2-hydroxyethyl propionate, 2-hydroxy-2-methyl methyl propionate, 2-hydroxy-2-methyl ethyl propionate, hydroxymethyl acetate, hydroxyethyl acetate, hydroxypropyl acetate, hydroxybutyl acetate, methyl lactate, ethyl lactate, propyl lactate, butyl lactate, 3-hydroxymethyl propionate, 3-hydroxyethyl propionate, 3-hydroxypropyl propionate, 3-hydroxybutyl propionate, 2-hydroxy-3-methyl methylbutyrate, methoxymethyl acetate, methoxyethyl acetate, methoxypropyl acetate, methoxybutyl acetate, ethoxymethyl acetate, ethoxyethyl acetate, ethoxypropyl acetate, ethoxybutyl acetate, propoxymethyl acetate, propoxyethyl acetate, propoxypropyl acetate, propoxybutyl acetate, butoxymethyl acetate, butoxyethyl acetate, butoxypropyl acetate, butoxybutyl acetate, 2-methoxymethyl propionate, 2-methoxyethyl propionate, 2-methoxypropyl propionate, 2-methoxybutyl propionate, 2-ethoxymethyl propionate, 2-ethoxyethyl propionate, 2-ethoxypropyl propionate, 2-ethoxybutyl propionate, 2-propoxymethyl propionate, 2-propoxyethyl propionate, 2-propoxypropyl propionate, 2-propoxybutyl propionate,_2-butoxymethyl propionate, 2-butoxyethyl propionate, 2-butoxypropyl propionate, 2-butoxybutyl propionate, 3-methoxymethyl propionate, 3-methoxyethyl propionate, 3-methoxypropyl propionate, 3-methoxybutyl propionate, 3-ethoxymethyl propionate, 3-ethoxyethyl propionate, 3-ethoxypropyl propionate, 3-ethoxybutyl propionate, 3-propoxymethyl propionate, 3-propoxyethyl propionate, 3-propoxypropyl propionate, 3-propoxybutyl propionate, 3-butoxymethyl propionate, 3-butoxyethyl propionate, 3-butoxypropyl propionate, and 3-butoxybutyl propionate.

The content of the solvent in the photosensitive resin composition is preferably from about 55 to about 90 wt. %. In this case, the photosensitive resin composition can form a film of a uniform thickness with reduced stains.

The photosensitive resin composition may further include several additives such as a coloring agent, a dye, an agent for preventing scratch, a plasticizer, an adhesion enhancer, a surfactant, an antioxidant, a dissolution inhibitor, a sensitizer, an UV absorbent, and a photostabilizer.

The photosensitive resin composition may be formed by mixing a solution containing an acrylic resin dissolved in a solvent and another solution containing quinone diazide. A solvent may be added to the mixture. It is preferable to remove solids by filtering the mixture, preferably by using a filter having a pore diameter less than about 3 microns and preferably from about 0.1 to about 2 microns. The acrylic resin and the quinone diazide may be dissolved in the same solvent. A plurality of solvents that can be mixed with each other may be used.

Now, a method for forming a film pattern from the photosensitive resin composition is provided.

A photosensitive film is coated on a substrate, exposed to light through a mask, and developed. The substrate may be made of transparent glass, silicon, aluminum, (doped) silicon dioxide, silicon nitride, tantalum, copper, polysilicon, ceramics, aluminum-copper mixture, or various plastics. One or more thin film patterns such as thin film transistors, color filters, organic light emitting diodes, etc., may be formed on the substrate before the photosensitive thin film is coated.

Examples of coating methods for the photosensitive film include slit coating using a coating device having slit-type nozzles, slit and spin coating in which the photosensitive resin composition flows through a slit on the substrate and rotates the substrate, dye coating, and curtain flow coating. The slit and spin coating is usually preferred. After the coating, the photosensitive resin composition may be subjected to vacuum drying under a pressure lower than ambient pressure to remove any remaining solvent. Thereafter, the photosensitive resin composition may be prebaked at about 20 to about 130° C. to remove volatile ingredients such as solvents without thermal decomposition of solid ingredients. The prebaking may be performed until the photoresist resin film has a thickness less than about two microns.

Next, the photosensitive film is subjected to a first exposure through a mask. The mask has a pattern suitable for the function of the hardened resin pattern. The light exposure sheds light (such as UV light) vertically over an entire surface of the photosensitive resin film, and aligns the mask with the photosensitive resin film using a mask aligner or a stepper.

The photoresist resin film is then developed by puddle development, immersion development, or spray development.

The development may be performed by using an alkaline aqueous solution. The alkaline aqueous solution contains an inorganic alkaline compound or an organic alkaline compound.

Examples of the inorganic alkaline compound include sodium hydroxide, potassium hydroxide, disodium hydrogen phosphate, sodium dihydrogen phosphate, diammonium hydrogen phosphate, ammonium dihydrogen phosphate, potassium dihydrogen phosphate, sodium silicate, potassium silicate, sodium carbonate, potassium carbonate, sodium hydrogen carbonate, potassium hydrogen carbonate, sodium borate, potassium borate, and ammonium.

Examples of the organic alkaline compound include tetramethylammonium hydroxide, 2-hydroxyethyltrimethylammonium hydroxide, monomethylamine, dimethylamine, trimethylamine, monoethylamine, diethylamine, triethylamine, monoisopropylamine, diisopropylamine, and ethanolamine.

Two or more of the above-listed alkaline compounds may be used in combination. The content of the alkaline compound is from about 0.01 to about 10 wt. %, and preferably from about 0.1 to about 5 wt. % of the total content of the developer.

The developer may contain a surfactant such as a nonionic surfactant, a cationic surfactant, and an anionic surfactant.

Two or more of the above-listed surfactants are used.

The developer may include an organic solvent including water soluble solvents such as methanol and ethanol.

The developer dissolves exposed portions of the photosensitive resin film, which are exposed to light, and leaves unexposed portions of the photosensitive resin film to form a film pattern.

Since the photosensitive resin composition includes quinone diazide, the exposed portions of the photosensitive resin film is quickly removed in a short time. In contrast, the unexposed portions are hardly removed even though they are in contact with the developer for a long time.

After the development, the substrate with the film pattern is cleaned for about 30-90 seconds with deionized water and dried.

At least a part of the film pattern is then subjected to a second light exposure preferably using (deep) ultraviolet (UV) ray. The illumination of UV on a unit area in the second light exposure may be higher than that in the first light exposure. The second light exposure removes the portions that may have been insufficiently exposed to light in the first light exposure to reduce the remnants.

The photosensitive resin pattern is postbaked at about 150° C. to about 250° C., and more preferably from about 180° C. to about 240° C. for about 5 to about 120 minutes, and more preferably from about 30 to about 90 minutes. The postbaking is performed by heating the substrate with a hot plate, a clean oven, etc. The postbaking improves the heat resistance and the solvent resistance of the cured photosensitive resin pattern.

### Embodiment 1

### SYNTHESIS EXAMPLE 1

### Acrylic Resin Synthesis

The following materials were put into a 200-ml flask provided with an agitator, a cooled tube, and a thermometer:

| | |
|---|---|
| 2,2′-azobis(2,4′-dimethyl valeronitrile | 10 parts by weight |
| propylene glycol monomethyl ether acetate | 200 parts by weight |
| methacrylate | 20 parts by weight |
| glycidyl methacrylate | 20 parts by weight |
| t-butyl norbornene carboxylate | 20 parts by weight |
| maleic unhydride | 20 parts by weight |
| styrene | 20 parts by weight |

The flask was then slowly agitated un,til the temperature of the interior of the flask reached 62° C., and the reaction was performed for about five hours under a nitrogen (N₂) atmosphere. As a result, an acrylic resin Al was obtained, which had an weight average molecular weight (Mw) of about 11,000 based on polystyrene standards.

The measurement of the average molecular weight was performed by GPC under the following conditions:

Device: HLC-8120GPC (manufactured by TOSOH Corporation in Japan)

Columns: TSK-GELG4000HXL+TSK-GELG2000HXL (serial connection) (manufactured by TOSOH Corporation in Japan)

Column Temperature: 40° C.

Solvent: tetrahydrofuran (THF)

Flow Rate: 1.0 ml/min

Injected Amount: 50 μl

Detector: RI (Refractive Index)

Concentration of Sample: 0.6wt %

Standard: TSK STANDARD POLYSTYRENE F40, F4, F-1, A-2500, A-500

### SYNTHESIS EXAMPLE 2

### 1,2-Quinone Diazide Synthesis

1 mol of 4,4′-[1-[4-[1-4-hydroxyphenyl]-1-methylethyl]phenyl]ethylidene]bisphenol and 2 mol of 1,2-naphthoquinone diazide-5-sulfonate[chloride] are subjected to condensation reaction to obtain [4,4′-[1-[4-[1-[4-hydroxyphenyl]-1-methylethyllphenyl]ethylidene]bisphenol-1,2-naphthoquinone diazide-5-sulfonate ester].

### EXAMPLE 1

### Preparation of Photosensitive Resin Composition 1

28 grams of acrylic resin A1, 7 grams of [4,4′-[1-[4-[1-[4-hydroxyphenyl]-1-methylethyl]phenyl]ethylidene]bisphenol-1,2-naphthoquinone diazide-5-sulfonate ester], and a solvent including 58.5 grams of propyleneglycol methyl ether acetate and 6.5 grams of trimethyl pentanediol monoisobutyrate are uniformly mixed, and they were filtrated through a millipore filter having a pore diameter of 0.2 microns to obtain a photosensitive resin composition 1.

### EXAMPLE 2

### Preparation of Photosensitive Resin Composition 2

Except for proportions of the ingredients shown in TABLE 1, the conditions and the materials were the same as those of Example 1 to obtain a photosensitive resin composition 2.

### EXAMPLE 3

### Preparation of Photosensitive Resin Composition 3

Except for proportions of the ingredients shown in TABLE 1, the conditions and the materials were the same as those of Example 1 to obtain a photosensitive resin composition 3.

### COMPARATIVE EXAMPLE 1

### Preparation of Photosensitive Resin Composition 4

Except for proportions of the ingredients shown in TABLE 1, the conditions and the materials were the same as those of Example 1 to obtain a photosensitive resin composition 4.

### COMPARATIVE EXAMPLE 2

### Preparation of Photosensitive Resin Composition 5

Except for proportions of the ingredients shown in TABLE 1, the conditions and the materials were the same as those of Example 1 to obtain a photosensitive resin composition 5.

### COMPARATIVE EXAMPLE 3

### Preparation of Photosensitive Resin Composition 4

Except for proportions of the ingredients shown in TABLE 1, the conditions and the materials were the same as those of Example 1 to obtain a photosensitive resin composition 6.

TABLE 1
Inredients for various resin compositions

| Division | Ex 1 | Ex 2 | Ex 3 | CE 1 | CE 2 | CE 3 |
|---|---|---|---|---|---|---|
| Polymer Resin | 28 | 28 | 28 | 28 | 28 | 28 |
| Photosensitive | 7.0 | 7.0 | 7.0 | 7.0 | 7.0 | 7.0 |
| Compound | | | | | | |
| PGMEA | 58.5 | 52 | 63.0 | 58.5 | 58.5 | 58.5 |
| TMPMB | 6.0 | 13 | 2.0 | | | |
| EL | | | | | 6.5 | |
| nBA | | | | | | 6.5 |

PGMEA: propylene glycol methyl ether acetate
TMPMB: trimethyl pentanediol monoisobutyrate
EL: ethyl lactate
nBA: n-butyl acetate

Estimated Extent of Stain Generation and Coating Uniformity

The photosensitive resin composition 1 (Example 1), the photosensitive resin composition 2 (Example 2), the photosensitive resin composition 3 (Example 3), the photosensitive resin composition 4 (Comparative Example 1), the photosensitive resin composition 5 (Comparative Example 2), and the photosensitive resin composition 6 (Comparative Example 3) were coated on six 400 mm×400 mm glass substrates, respectively, by using a slit coater. Thereafter, the thickness of the transparent cured resins formed by heating and drying were measured 20 times in a horizon direction and 15 times in a vertical direction to obtain maximum and minimum thicknesses and the thickness uniformity given the following equation was calculated as shown in TABLE 2:.
Thickness Uniformity (%)=[(maximum thickness−minimum thickness)/(maximum thickness+minimum thickness)]×100

Surface observations of stains under a halogen lamp gave the results illustrated in TABLE 2.

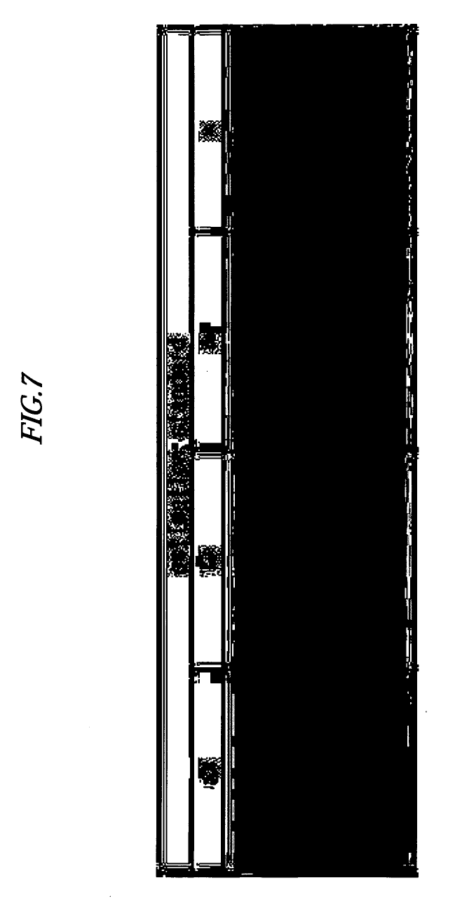

Here, it is noted that the standard for the estimation of the stains in TABLE 2 is illustrated in FIG. 7.

TABLE 2
Summary of Thickness Uniformity and Stains for Examples

| | Thickness | Stain |
|---|---|---|
| | Uniformity (%) | Characteristics |
| Ex 1 | 2.16 | Good |
| Ex 2 | 1.84 | Excellent |
| Ex 3 | 2.41 | Good |
| CE 1 | 5.28 | Bad |
| CE 2 | 4.21 | Poor |
| CE 3 | 8.81 | Bad |

As shown in TABLE 2, the use of the inventive photosensitive resin appropriately controls the spreading of the ingredients and the drying speed of the solvent and thus the stain characteristic and the thickness uniformity are significantly improved as compared with the Comparative Examples.

### Embodiment

Now, thin film transistor (TFT) array panels for liquid crystal display (LCD) including an insulating layer made from the above-described photosensitive resin composition 2 and manufacturing methods thereof are described in detail with reference to accompanying drawings.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

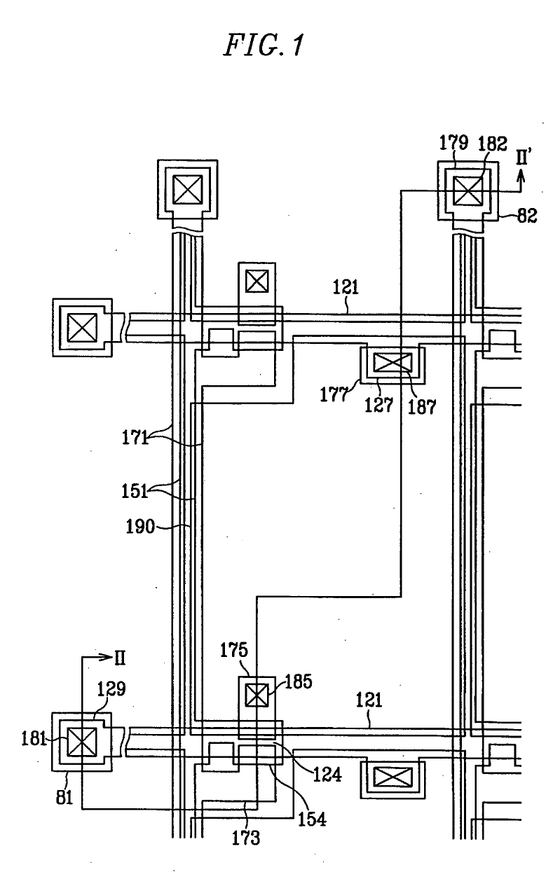

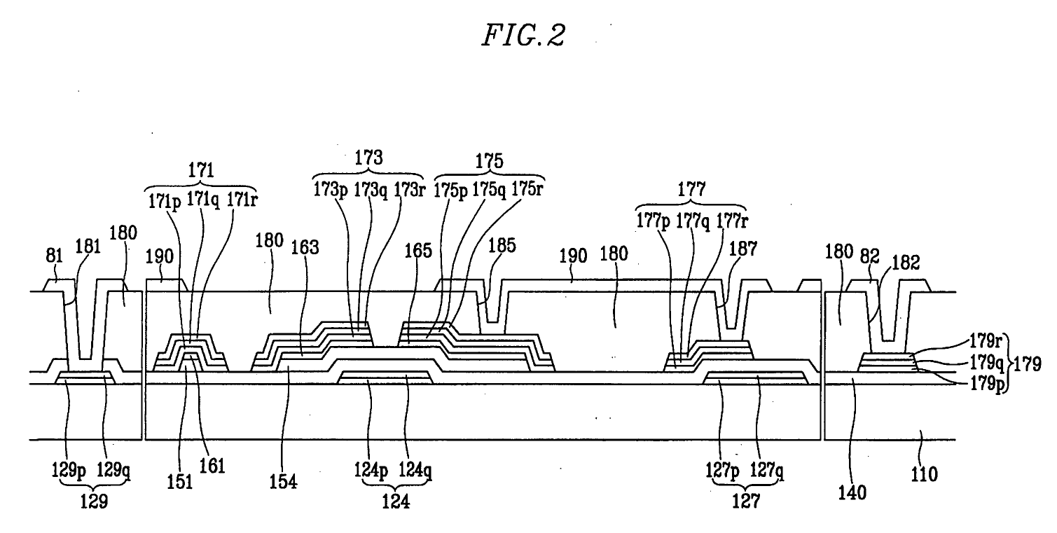

First, a thin film transistor (TFT) array panel according to an embodiment of the present invention will be described in detail with reference to FIGS. 1 and 2.

FIG. 1 is a layout view of a TFT array panel according to an embodiment of the present invention and FIG. 2 is a sectional view of the TFT array panel shown in FIG. 1 taken along line II-II′.

A plurality of gate lines 121 are formed on an insulating substrate 110 such as transparent glass or plastic.

The gate lines 121 transmrit gate signals and extend substantially in a first direction, which is the transverse direction in FIG. 1. Each gate line 121 includes a plurality of gate electrodes 124, a plurality of projections 127 projecting downward with respect to FIG. 1, and an end portion 129 having a large area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated onto the substrate 110. The gate lines 121 may extend to be connected to a driving circuit that may be integrated on the substrate 110.

The gate lines 121 include two conductive films, a lower film and an upper film disposed thereon, which have different physical characteristics. The lower film is preferably made of low-resistivity metal such as an Al-containing metal such as Al and Al alloy, an Ag-containing metal such as Ag and Ag alloy, or a Cu-containing metal such as Cu and Cu alloy, for reducing signal delay or voltage drop. The upper film is preferably made of a material that has good physical, chemical, and electrical contact characteristics with other materials such as indium tin oxide (ITO) or indium zinc oxide (IZO). Examples of materials that may be suitable for the upper film include a Mo-containing metal such as Mo and Mo alloy, Cr, Ta, or Ti. In one embodiment, the lower film is an Al (alloy) film and the upper film is a Mo (alloy) film.

The lower film may be made of good contact material, and the upper film may be made of low-resistivity material. In this case, the upper film 129q of the end portions 129 of the gate lines 121 may be removed to expose the lower film 129p. In addition, the gate lines 121 may include a single layer preferably made of the above-described materials. Otherwise, the gate lines 121 may be made of various metals or conductors.

In FIGS. 2A and 2B, for the gate electrodes 124 and the projections 127, the lower and upper films thereof are denoted by additional characters p and q, respectively.

The lateral sides that form the edges of the gate lines 121 are inclined to form inclination angles of about 30-80 degrees with a surface of the substrate 110.

A gate insulating layer 140, which is preferably made of silicon nitride (SiNx) or silicon oxide (SiOx), is formed on the gate lines 121.

A plurality of semiconductor stripes 151, which are preferably made of hydrogenated amorphous silicon (abbreviated to “a-Si”) or polysilicon, are formed on the gate insulating layer 140. Each semiconductor stripe 151 extends substantially in a second direction that is perpendicular to the first direction. The second direction is the longitudinal direction in FIG. 1. The semiconductor stripe 151 becomes wide near the gate lines 121 such that the semiconductor stripes 151 cover a large portion of the gate lines 121. Each semiconductor stripe 151 has a plurality of projections 154 branching out toward the gate electrodes 124.

A plurality of ohmic contact stripes and islands 161 and 165 are formed on the semiconductor stripes 151. The ohmic contact stripes and islands 161 and 165 are preferably made of an n+ hydrogenated a-Si heavily doped with an n-type impurity such as phosphorus. Alternatively, the ohmic contact stripes and islands 161,165 may be made of silicide. Each ohmic contact stripe 161 has a plurality of projections 163, and the projections 163 and the ohmic contact islands 165 are located in pairs on the projections 154 of the semiconductor stripes 151.

The lateral sides of the edges of semiconductor stripes 151 and the ohmic contacts 161 and 165 are inclined to form inclination angles preferably in a range of about 30-80 degrees relative to a surface of the substrate.

A plurality of data lines 171, a plurality of drain electrodes 175, and a plurality of storage conductors 177 are formed on the ohmic contacts 161 and 165 and the gate insulating layer 140.

The data lines 171 transmit data signals and extend substantially in the second direction to intersect the gate lines 121. Each data line 171 includes a plurality of source electrodes 173 projecting toward the gate electrodes 124 and an end portion 179 having a large area for contact with another layer or an external driving circuit. A data driving circuit (not shown) for generating the data signals may be mounted on a FPC film (not shown), which may be attached to the substrate 110, directly mounted on the substrate 110, or integrated onto the substrate 110. The data lines 171 may extend to be connected to a driving circuit that may be integrated on the substrate 110.

The drain electrodes 175 are separated from the data lines 171 and disposed opposite the source electrodes 173 with respect to the gate electrodes 124.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The storage conductors 177 are disposed on the projections 127 of the gate lines 121.

The data lines 171, the drain electrodes 175, and the storage conductors 177 may have a triple-layered structure including a lower film 171p, 175p and 177p, an intermediate film 171q, 175q and 177q, and an upper film 171r, 175r and 177r. The lower films 171p, 175p and 177p are preferably made of a refractory metal such as Cr, Mo, Ta, Ti, or alloys thereof, the intermediate films 171q, 175q and 177q are preferably made of a low-resistivity metal such as an Al-containing metal, an Ag-containing metal, and a Cu-containing metal, and the upper films 171r, 175r and 177r are made of a refractory metal or alloys thereof having a good contact characteristic with ITO or IZO. in some embodiments, the data lines 171, the drain electrodes 175, and the storage conductors 177 may have a double-layered structure including a refractory-metal lower film (not shown) and a low-resistivity upper film (not shown) or a single-layer structure preferably made of the above-described materials. However, these structures are not limitations of the invention and the data lines 171, the drain electrodes 175, and the storage conductors 177 may be made of any metals or conductors deemed suitable by a person of ordinary person in the art.

In FIG. 2, for the source electrodes 173 and the end portions 179 of the data lines 179, the lower, the intermediate, and the upper films thereof are denoted by additional characters p, q and r, respectively.

The data lines 171, the drain electrodes 175, and the storage conductors 177 have inclined edges that form inclination angles of about 30-80 degrees with respect to the surface of the gate insulating layer 140.

The ohmic contacts 161 and 165 are interposed only between the underlying semiconductor stripes 151 and the overlying conductors 171 and 175 deposited thereon and reduce the contact resistance between the ohmic contact 161 and the semiconductor stripe 151, and between the ohmic contact 165 and the semiconductor stripe 151. Although the semiconductor stripes 151 are narrower than the data lines 171 at most places, the width of the semiconductor stripes 151 increase near the gate lines 121 as described above to smooth the profile of the surface, thereby preventing the disconnection of the data lines 171. The projections 154 of the semiconductor stripes 151 include some exposed portions that are not covered with the data lines 171, the drain electrodes 175, and the storage conductors 177. An example of these exposed portions include the portions located between the source electrodes 173 and the drain electrodes 175.

A passivation layer 180 is formed on the data lines 171, the drain electrodes 175, the storage conductors 177, and the exposed portions of the semiconductor stripes 151.

The passivation layer 180 is preferably made of a photosensitive organic insulator having a dielectric constant that is preferably less than about 4.0. The passivation layer 180 may have a flat surface and a thickness from about 1.0 to about 8.0 microns.

The organic insulator for the passivation 180 is a photosensitive resin composition including an acrylic resin, a quinone diazide, and a solvent. The solvent includes a propylene glycol alkyl ether acetate including an alkyl group preferably containing about 1-5 carbon atoms and a trimethyl pentanediol monoisobutyrate.

The solvent in the photosensitive resin composition has an improved solubility for solid ingredients such as the acrylic resin and the quinone diazide to make the photosensitive resin composition uniformly spread. In addition, the photosensitive resin composition regulates the volatilization rate of the solvent to reduce stains caused by incomplete or slow drying of the solvent. As a result, the thickness of the passivation layer 180 is uniform, improving the transmissive and the reflective characteristics of the passivation layer 180.

The passivation layer 180 may include a lower film of inorganic insulator such as silicon nitride or silicon oxide and an upper film of the above-described organic insulator such that it takes the excellent insulating characteristics of the organic insulator while preventing the exposed portions of the semiconductor stripes 151 from being damaged by the organic insulator.

The passivation layer 180 has a plurality of contact holes 182, 185 and 187 exposing the end portions 179 of the data lines 171, the drain electrodes 175, and the storage conductors 177, respectively. The passivation layer 180 and the gate insulating layer 140 have a plurality of contact holes 181 exposing the end portions 129 of the gate lines 121.

A plurality of pixel electrodes 190 and a plurality of contact assistants 81 and 82 are formed on the passivation layer 180. They are preferably made of a transparent conductor such as ITO or IZO or reflective conductor such as Ag, Al, Cr, or alloys thereof.

The pixel electrodes 190 are physically and electrically connected to the drain electrodes 175 through the contact holes 185 and connected to the storage conductors 177 through the contact holes 177 such that the pixel electrodes 190 receive data voltages from the drain electrodes 175 and transmit the data voltages to the storage conductors 177. The pixel electrodes 190 supplied with the data voltages generate electric fields in cooperation with a common electrode (not shown) of an opposing display panel (not shown) supplied with a common voltage, which determine the orientations of liquid crystal molecules (not shown) of a liquid crystal layer (not shown) disposed between the two electrodes. A pixel electrode 190 and the common electrode form a capacitor referred to as a “liquid crystal capacitor,” which stores applied voltages after the TFT turns off.

A pixel electrode 190 overlaps a projection 127 of a previous gate line 121. The pixel electrode 190 and a storage conductor 177 connected thereto and the projection 127 form an additional capacitor referred to as a “storage capacitor,” which enhances the voltage storing capacity of the liquid crystal capacitor.

The pixel electrodes 190 overlap the gate lines 121 and the data lines 171 to increase the aperture ratio.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

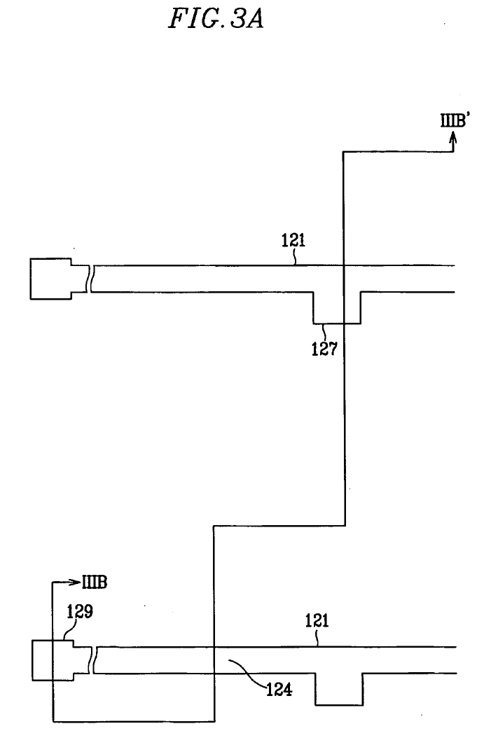

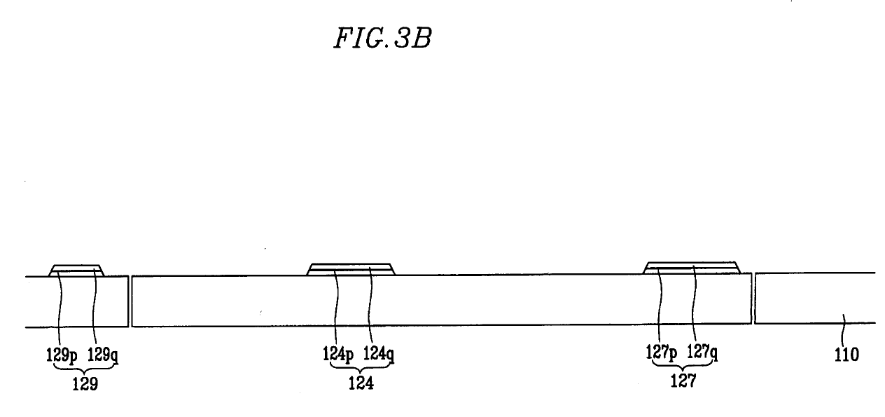

A method for manufacturing the TFT array panel shown in FIGS. 1 and 2 according to an embodiment of the present invention will be described with reference to FIGS. 3A-6B as well as FIGS. 1 and 2.

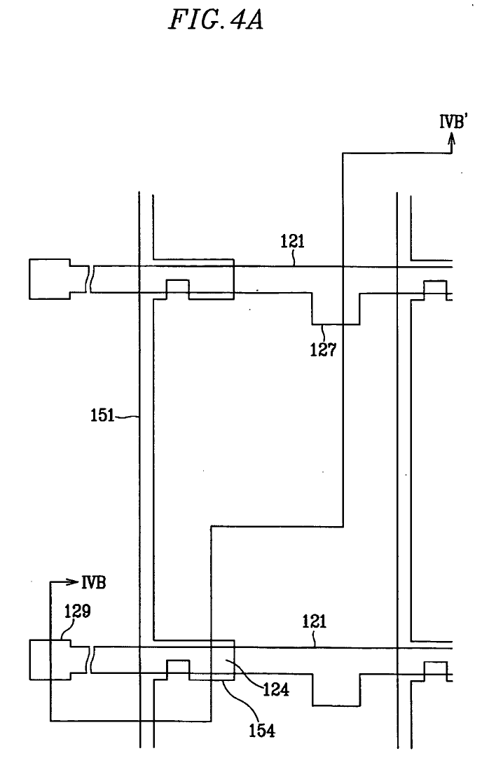

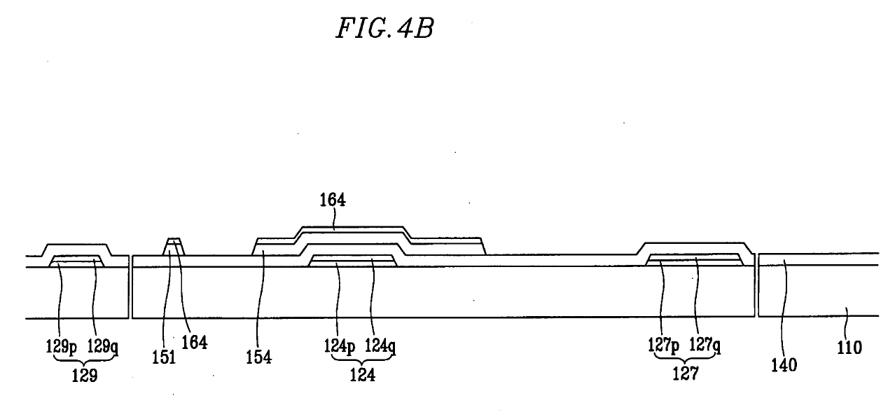

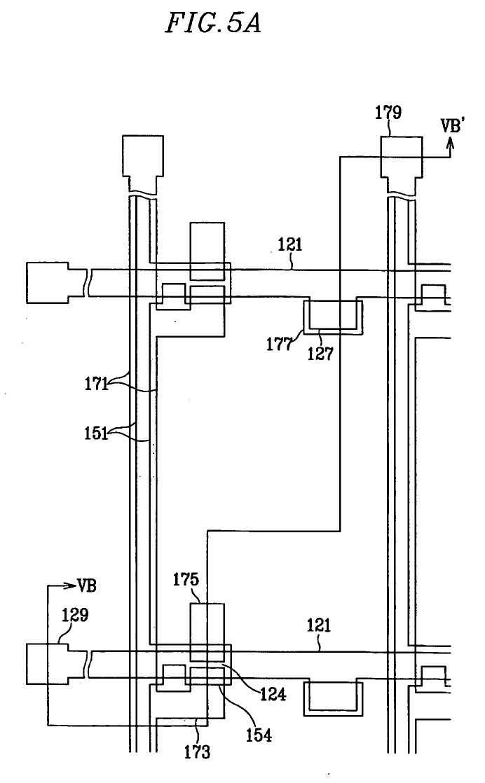

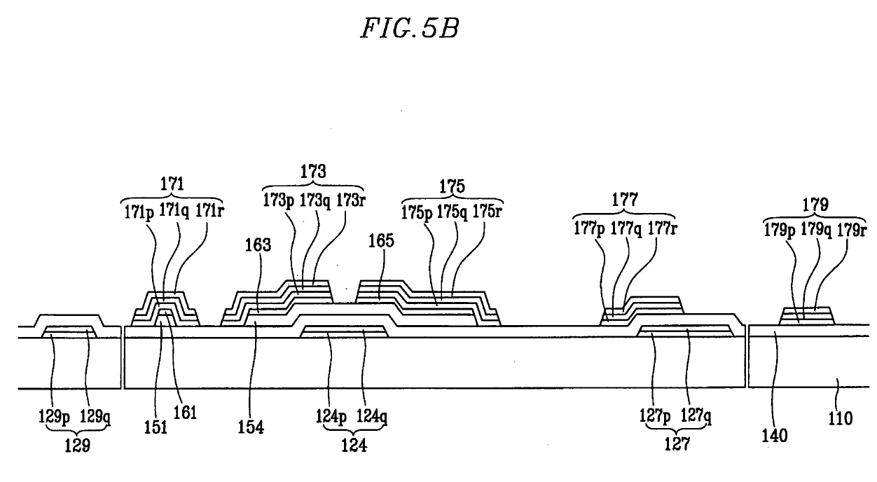

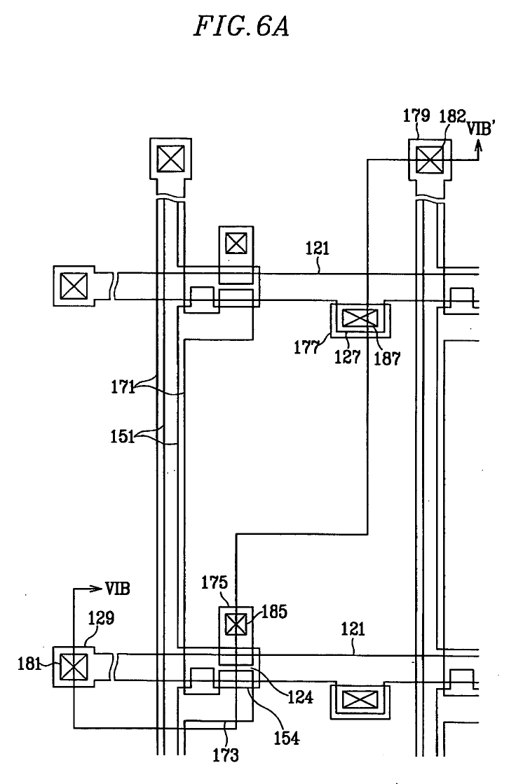

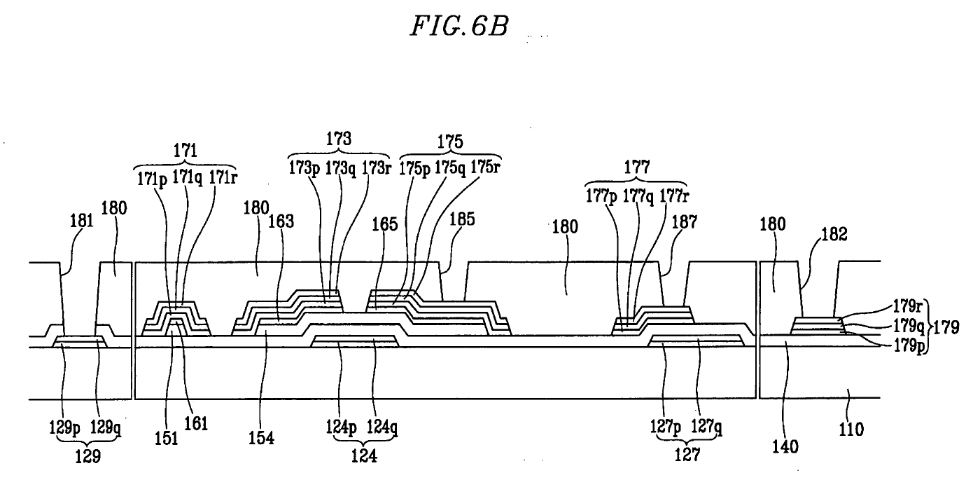

FIGS. 3A, 4A, 5A and 6A are layout views of the TFT array panel shown FIGS. 1 and 2 including intermediate steps of its manufacturing method according to an embodiment of the present invention, FIG. 3B is a sectional view of the TFT array panel shown in FIG. 3A taken along line IIIB-IIIB′, FIG. 4B is a sectional view of the TFT array panel shown in FIG. 4A taken along line IVB-IVB′, FIG. 5B is a sectional view of the TFT array panel shown in FIG. 5A taken along line VB-VB′, and FIG. 6B is a sectional view of the TFT array panel shown in FIG. 6A taken along line VIB-VIB′.

Referring to FIGS. 3A and 3B, a conductive layer is deposited on an insulating substrate 110 by sputtering, etc. The conductive layer has a lower film preferably made of Al or Al—Nd alloy and having a thickness of preferably about 2,500 Å and an upper film preferably made of Mo.

The lower and the upper films may be co-sputtered using an Al or Al—Nd target and a Mo target. When the lower film is deposited, the Al(—Nd) target is powered, while the Mo target is unpowered. After the deposition of the lower film, the Al(—Nd) target is unpowered and the Mo target is powered to deposit the upper film.

The upper and the lower films are patterned by lithography and etching to form a plurality of gate lines 121 including gate electrodes 124, projections 127, and end portions 129.

Referring to FIGS. 4A and 4B, a gate insulating layer 140 having a thickness of from about 2,000 to about 5,000 Å is deposited at from about 250 to about 500° C. Subsequently, an intrinsic amorphous silicon layer and an extrinsic amorphous silicon layer are sequentially deposited on the gate insulating layer 140 and patterned by lithography and etching to form a plurality of extrinsic semiconductor stripes 164 and a plurality of intrinsic semiconductor stripes 151 including projections 154.

Referring to FIGS. 5A and 5B, a conductive layer is deposited by sputtering, etc. The conductive layer includes a lower film preferably made of Mo, an intermediate film preferably made of Al, and an upper film preferably made of Mo. The thickness of the conductive layer is equal to about 4,000 Å and the sputtering temperature is equal to about 150° C.

The conductive layer is then patterned by lithography and wet etched to form a plurality of data lines 171 including source electrodes 173 and end portions 179, the drain electrodes 175, and the storage conductors 177. The etchant for the wet etch may include phosphoric acid of preferably about 63-70%, nitric acid of preferably about 48%, or acetic acid of preferably about 8-11%, with the rest being deionized water.

Thereafter, exposed portions of the extrinsic semiconductor stripes 164, which are not covered with the data lines 171, the drain electrodes 175, and the storage conductors 177, are removed to complete a plurality of ohmic contact stripes 161 including projections 163 and a plurality of ohmic contact islands 165 and to expose portions of the intrinsic semiconductor stripes 151. Oxygen plasma treatment preferably follows in order to stabilize the exposed surfaces of the semiconductor stripes 151.

Referring to FIGS. 6A and 6B, a photosensitive resin film including an acrylic resin, a quinone diazide, and a solvent is coated. The solvent includes a propylene glycol alkyl ether acetate including an alkyl group preferably containing about 1-5 carbon atoms and a trimethyl pentanediol monoisobutyrate.

The coating is performed by slit coating with moving the substrate 110 or a nozzle (not shown) of a coater (not shown) and the thickness of the coated resin composition is from about 1.0 to about 8.0 microns.

After the coating, the substrate 110 coated with the photosensitive resin composition is put into an oven and prebaked for about 90 to about 180 seconds at a temperature of from about 90 to about 110° C. The prebaking removes volatile ingredients such as solvents.

Next, the photosensitive film is aligned with a mask by using a mask aligner and subjected to a first exposure through the mask. The light exposure vertically illuminates an entire surface of the photosensitive resin film with, for example, UV ray.

The photoresist resin film is then developed with a developer of an alkaline aqueous solution preferably containing 3 wt. % diisopropyl amine. The developer dissolves exposed portions of the photosensitive resin film, which are exposed to light, and leaves unexposed portions of the photosensitive resin film to form a passivation layer 180 having a plurality of contact holes 182, 185 and 187 and upper portions of a plurality of contact holes 181 as shown in FIGS. 6A and 6B.

Since the photosensitive resin composition includes quinone diazide, the exposed portions of the photosensitive resin film is quickly removed in a short time. In contrast, the unexposed portions are hardly removed even though they are in contact with the developer for a long time.

After the development, the substrate 110 with the passivation layer 180 is cleaned with deionized water and dried.

A portion or an entire portion of the passivation layer 180 is then subjected to a second light exposure preferably using (deep) ultraviolet (UV) ray. The illumination of UV on unit area in the second light exposure may be higher than that in the first light exposure. The second light exposure removes the portions that may have been insufficiently exposed to light during the first light exposure to reduce the remnants.

The passivation layer 180 is postbaked for about 5 to about 120 minutes and preferably for from about 30 to about 90 minutes in a hot plate or a clean oven at a temperature from about 150° C. to about 250° C. and more preferably from about 180° C. to about 240° C. The postbaking improves the heat resistance and the solvent resistance of the cured photosensitive resin pattern.

The solvent in the photosensitive resin composition has an improved solubility for solid ingredients such as the acrylic resin and the quinone diazide to make the photosensitive resin composition uniformly spread. Accordingly, the photosensitive resin composition regulates the volatilization rate of the solvent to reduce stains caused by incomplete or slow drying of the solvent. In addition, the photosensitive resin composition forms a uniformly thick passivation layer 180 to improve the transmissive and the reflective characteristics of the passivation layer 180.

Subsequently, the gate insulating layer 140 is etched using the passivation layer 180 as an etch mask to complete the contact holes 181.

Finally, a plurality of pixel electrodes 190 and a plurality of contact assistants 81 and 82 are formed on the passivation layer 180 and on the exposed portions of the drain electrodes 175, the end portions 129 of the gate lines 121, and the end portions 179 of the data lines 171 by sputtering, lithography, and etching an IZO or ITO layer as shown FIGS. 1 and 2.

The above-described photosensitive resin. composition may be employed to other insulating layers such as the gate insulating layer 140. In addition, the above-described photosensitive resin composition may be employed to other display devices such as organic light emitting diode (OLED) display.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A photosensitive resin composition comprising:
an acrylic resin;
a quinone diazide; and
a solvent that includes:
a propylene glycol alkyl ether acetate having an alkyl group containing about 1-5 carbon atoms; and
a trimethyl pentanediol monoisobutyrate.

2. The composition of claim 1, wherein the weight percentage of the propylene glycol alkyl ether acetate in the solvent is from about 60 to about 95 wt. % and the weight percentage of the trimethyl pentanediol monoisobutyrate is preferably from about 5 to about 40 wt. %.

3. The composition of claim 1, wherein the weight percentage of the solvent in the composition is from about 55 to about 90 wt. %.

4. The composition of claim 1, wherein the weight percentage of the acrylic resin in the composition is from about 5 to about 40 wt. %.

5. The composition of claim 1, wherein the weight percentage of the quinone diazide in the composition is from about 2 to about 15 wt. %.

6. The composition of claim 1, wherein the weight percentage of the propylene glycol alkyl ether acetate in the solvent is from about 75 to about 85 wt. % and the weight percentage of the trimethyl pentanediol monoisobutyrate is from about 15 to about 25 wt. %.

7. The composition of claim 1, wherein the acrylic resin comprises a norbomene carboxylate having 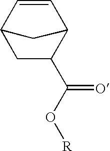
where R is —OH or —CH₃.

8. The composition of claim 7, wherein the weight percentage of the norbornene carboxylate in the composition is from about 20 to about 40 wt. %.

9. The composition of claim 1, wherein the composition further comprises at least one of a coloring agent, a dye, an agent for preventing scratch, a plasticizer, an adhesion enhancer, a surfactant, an antioxidant, a dissolution inhibitor, a sensitizer, an UV absorbent, and a photostabilizer.

10. A thin film panel comprising:
a substrate;
a thin film pattern formed on the substrate; and
an insulating layer formed on the thin film pattern, the insulating layer being made from a photosensitive resin composition including an acrylic resin, a quinone diazide, and a solvent including:
a propylene glycol alkyl ether acetate having an alkyl group containing about 1-5 carbon atoms; and
a trimethyl pentanediol monoisobutyrate.

11. The thin film panel of claim 10, wherein the weight percentage of the propylene glycol alkyl ether acetate in the solvent is from about 60 to about 95 wt. % and the weight percentage of the trimethyl pentanediol monoisobutyrate is preferably from about 5 to about 40 wt. %.

12. The thin film panel of claim 10, wherein the thin film pattern comprises:
a gate line;
a gate insulator formed on the gate line;
a semiconductor layer formed on the gate insulator; and
a data line and a drain electrode formed on the semiconductor layer.

13. The thin film panel of claim 12, further comprising a pixel electrode formed on the insulating layer and connected to the drain electrode.

14. A method of manufacturing a thin film panel, the method comprising:
forming a thin film pattern on a substrate;
coating a photosensitive resin composition including an acrylic resin, a quinone diazide, and a solvent;
performing a light exposure on the photosensitive resin composition; and
developing the photosensitive resin composition, wherein the solvent comprises:
a propylene glycol alkyl ether acetate having an alkyl group containing about 1-5 carbon atoms; and
a trimethyl pentanediol monoisobutyrate.

15. The method of claim 14, wherein the coating of the photosensitive resin composition uses a slit type nozzle.

16. The method of claim 14, wherein the photosensitive resin composition has a thickness from about 1.0 to about 8.0 microns.

17. The method of claim 14, wherein further comprising:
removing the solvent from the photosensitive resin composition before the light exposure.

18. The method of claim 14, wherein further comprising:
exposing the photosensitive resin composition to light after the development.

19. The method of claim 14, wherein further comprising:
baking the photosensitive resin composition after the development.

20. The method of claim 14, wherein the formation of the thin film pattern comprises:
forming a gate line on the substrate;
depositing a gate insulating layer and a semiconductor layer in sequence;
etching the semiconductor layer; and
forming a data lines and a drain electrode on the semiconductor layer.

21. The method of claim 20, further comprising:
forming a pixel electrode on the photosensitive resin composition,
wherein the photosensitive resin composition has a contact hole exposing the drain electrode and the pixel electrode is connected to the drain electrode.
